(19) United States
(12) Patent Application Publication
(10) Pub. No.: US 2002/0188945 A1
(43) Pub. Date: Dec. 12, 2002

(54) Enhanced EPG to find program start and segments

(76) Inventors: Tom McGee, Gamson, NY (US); Nevenka Dimitrova, Yorktown Heights, NY (US); Lalitha Agnihotri, Fishkill, NY (US)

Correspondence Address: Dico Halajian, Esq., Philips Electronics North America Corporation, 580 White Plains Road, Tarrytown, NY, 10591-5190, US

(21) Appl. No.: 09/876,198

(22) Filed: Jun. 6, 2001

(51) Int. Cl. G06F 3/00; H04N 5/445; G06F 13/00; H04N 7/173; H04N 7/16

(52) U.S. Cl. 725/39; 725/55; 725/133; 725/141; 725/153

(57) ABSTRACT

A method of processing a catalog of electronic programming information, in which the catalog contains information for a program, including a start time and end time of the program, and in which the program is represented by characteristics data gathered from the program, where the processing includes monitoring a programming video input for the characteristics data from the start and/or end times of a program to control the display and/or recording of the program.

### FIELD OF THE INVENTION

The present invention relates to methods of and systems for detection of program start and end times in broadcast video using an Electronic Programming Guide (“EPG”), in conjunction with other signature data extracted or generated from the broadcast signal

### BACKGROUND OF THE INVENTION

Users of televisions frequently make use of television programming guides to select programs to view and/or record. Television guides have recently become available in electronic form, as Electronic Programming Guides (“EPG”), which currently contain information regarding the start time, end time, and channel or station at which a program will be broadcast.

Modem EPG's allow a user of a television receiver device to select a program to view or record from the EPG, and have the start time, end time, and channel or station selection downloaded to the receiver. The receiver may then control viewing and/or recording devices to be turned on and tuned in to the selected program when it airs.

One problem with the current state of the art is that the EPG-stored times are often only approximate, and a last-minute scheduling change or delay can cause the program selected by the user to begin and end later than scheduled in the EPG.

As an example scenario, the user wants to record Peter Pan. The EPG says Peter Pan starts on Monday after Monday Night Football. Monday Night Football is scheduled to end at 11:30 PM EST. In actuality, the football game goes into overtime and doesn't end until 11:45 PM EST, and the time slot for Peter Pan is shifted 15 minutes.

A receiver controlling a recording device in accordance with the present state of the art will signal the recording device to begin recording at 11:30 PM and end recording at 12:00 AM. The last 15 minutes of the football game will be recorded, followed by the first 15 minutes of Peter Pan. The last 15 minutes of Peter Pan will not be recorded.

### SUMMARY OF THE INVENTION

The present invention, which addresses the needs of the prior art, provides in an embodiment, a method of processing a catalog of electronic programming information, in which the catalog contains information for a program, including a start time and end time of the program, and in which the program is represented by characteristics data gathered from the program.

The method involves obtaining a value representing the characteristics data from a video program, at the start time of the program. Next, store the value representing the characteristics data from a video segment at the start time of the program in the catalog.

Then, obtain a value representing the characteristics data from a video segment from the end time of the program, and storing this value into the EPG catalog. When a user selects the program listed in the EPG catalog, copy the values representing the characteristics data from the start and end times to the device. Next, monitor the electronic program input video data, searching for a match with the characteristics from the start and end times of listed in the EPG.

When the characteristics data from the video input for the selected channel matches the characteristics data from the start time of the program, the device begins the viewing or recording, or other use activity, of the selected program.

In another embodiment, the device then compares the value representing the characteristics data from a video sequence from the end time of the program with the values representing the characteristics data from the video input. When the value representing the characteristics data from the end time of the program matches the value representing the characteristics from the video input, the device ends its use for the program.

Another embodiment of the invention describes a system for processing a catalog of electronic programming information, in which the catalog contains information for a program, in which a start time and end time of the program is stored, and in which the program is represented by characteristics data gathered from the program. The system includes a video signal source of the program and a processor operatively coupled to the video signal source. The processor is also coupled to a electronic programming guide, a user selection device, and logic output means. The processor is configured to operate the methods herein described, accepting user programming selections from the user selection device, and program start and end characteristics data, program channel selection and start and end times from the EPG. The processor then operates the connected monitor to start and end program display as described in the methods described herein.

In another embodiment, the processor operates a program recording device instead of the monitor.

### BRIEF DESCRIPTION OF THE DRAWINGS

FIG. 1 is a block diagram of a system using EPG and signal characteristics to control recording and/or display devices.

FIG. 2 shows an example of block signature extraction using a DCT method.

### DETAILED DESCRIPTION OF THE PREFERRED EMBODIMENT

The following description is presented to enable any person of ordinary skill in the art to make and use the present invention. Various modifications to the preferred embodiment will be readily apparent to those of ordinary skill in the art, and the disclosure set forth herein may be applicable to other embodiments and applications without departing from the spirit and scope of the present invention and the claims hereto appended. Thus, the present invention is not intended to be limited to the embodiments described, but is to be accorded the broadest scope consistent with the disclosure set forth herein.

The present invention addresses the problem of EPG start times often being only approximations by allowing signatures to be generated representing frames from the beginning and end of a program and stored in the EPG catalog. These signatures are retrieved when a user selects the program from the EPG for viewing or recording. A system using the invention may then monitor the channel, beginning close to the time the program is scheduled to air (from the EPG). When the signature generated by monitoring the channel matches that stored in the EPG, the system then knows to begin the display and/or recording of the program.

Similarly, the system may continue to monitor for the signature indicating the end of the program, so as to stop the display and/or recording at the proper time. Alternatively, the system could cease monitoring until a time near the scheduled program end time.

Another embodiment of the invention can handle the case of when program start and/or end signatures are not available beforehand, such as might be the case for live broadcasts, sports, weather or news. In this embodiment a display/recording device may begin to buffer the selected channel or station a short time before the broadcast is scheduled to begin in the EPG. The EPG is also continuously monitored, and the broadcaster inserts the start and/or end signature into the EPG as soon as possible. The display/recording device may then begin display/recording at the point in its buffer where the starting signature is located, and terminate display/recording where the end signature is found.

Another aspect of the invention involves the display of the selected program, while another involves the recording of the selected program.

Additional embodiments involve values representing characteristics data of signatures generated by using a combination of features from a frame of the program, while yet another uses color histograms generated from a frame of the program.

In another embodiment of the invention, the value representing characteristics data gathered from said program is generated from closed captioning data gathered from one or more frames of the program.

In another embodiment of the invention the value representing characteristics of the program is a signature generated for a block of DCT values for a frame.

In another embodiment of the invention the value representing characteristics of the program is a signature generated using the audio for one or more frames.

In another embodiment of the invention the value representing characteristics of the program is a signature generated from a combination of the above embodiments.

There are many possible characteristics that may comprise the program start and end signatures, as discussed below.

### DCT Frame Signatures

A frame signature representation is derived for each grouping of similarly valued DCT blocks in a frame, i.e., a frame signature is derived from region signatures within the frame. Each region signature is derived from block signatures as explained herein. Qualitatively, the frame signatures contain information about the prominent regions in the video frames representing identifiable objects. The signatures of this frame can then be used to retrieve this portion of the video.

### Extracting Block, Region and Frame Signatures

Based on the DC and highest values of the AC coefficients, a signature is derived for each block in the frame. Next, the size and location of blocks with similar signature are used in order to derive region signatures.

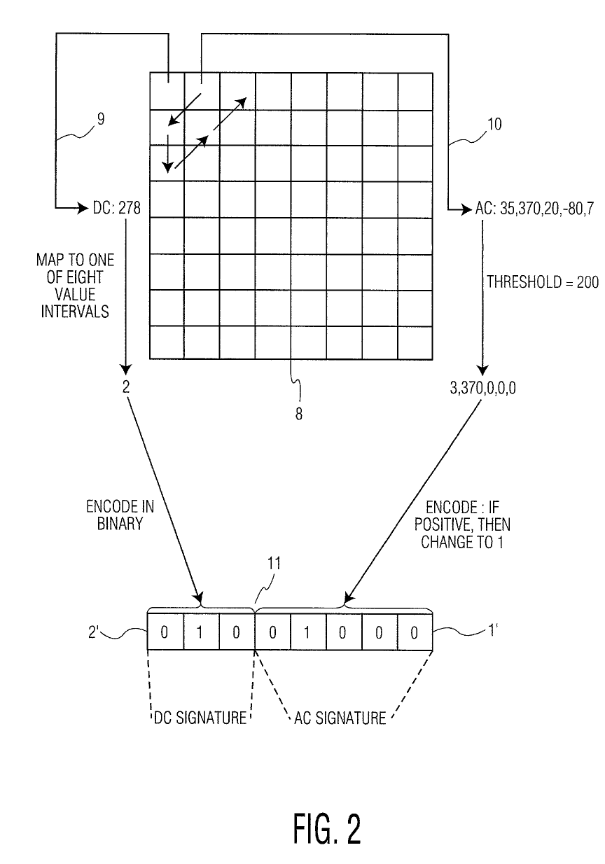

FIG. 2 shows an example of block signature extraction where the block signature is eight bits long, out of which three bits are devoted to the DC 2′ and five bits are devoted to the AC 1′ values. The DC part of the signature is derived by determining where the DC value falls within the specified range of values (e.g.−2400 to 2400). The range is divided into a pre-selected number of intervals. When three bits are devoted to the DC values, up to eight intervals can be used. Depending on the type of application, the size of the whole signature can be changed to accommodate a larger number of intervals and therefor finer granularity representation. Each interval is assigned a predefined mapping from the range of DC values to the DC part of the signature.

Each AC value is compared to a threshold. If the value is greater than the threshold, the corresponding bit in the AC signature is set to one. After deriving block signatures for each frame, regions of similarly valued block signatures are determined. Regions consist of two or more blocks that share similar block signatures. In this process, a region growing method is used for isolating regions in the image.

Traditionally, region growing methods use pixel color and neighborhood concepts to detect regions. Herein, block signature is used as a basis for growing regions. Each region is then assigned a region signature: regionSignature(mblockSignature, regionSize, Rx, Ry), where Rx and Ry are the coordinates of the center of the region. Each region corresponds roughly to an object in the image.

A selected frame is represented by the most prominent groupings (regions) of DCT blocks. An n-word long signature is derived for a frame where n determines the number of important regions (defined by the application) and a word consists of a predetermined number of bytes. Each frame can be represented by a number of prominent regions. One possible implementation is to limit the number of regions in the image and keep only the largest regions. Because one frame is represented by a number of regions, we can regulate the similarity between frames by choosing the number of regions that are similar, based on their block signature, size and location. Regions are sorted by region size, and then select the top n region signatures as a representative of the frame: frame(regionSignaturel,. . . regionSignaturen). It should be noted here that this representation of keyframes is based on the visual appearance of the images, and does not attempt to describe any semantics of the images.

### Frame Matching

To find the start or end of a video sequence, a frame comparison procedure compares a video frame F″ signature with the signature from an EPG. Their respective region signatures are compared according to their size:

frame_difference=region_size′ - region_size″

The frame difference can be calculated for the regions in the frame signature with the same centroids. In this case, the position of the objects as well as the color content is taken into account to generate signatures. Alternatively, there are cases when the position is irrelevant and one needs to compare just the region sizes and disregard the position of the region. If the frame difference is zero, the position information from the matching frame can be used to signal the start or end of a video sequence.

### Other Frame Signature Types

Signatures can be created by other low level frame features. Signatures can be created by using a combination of features from the frames, such as the mean absolute difference (“MAD”) between the current and preceding and/or following frame. The intensity of the frame, bitrate used for the frame, whether frame is interlaced or progressive, and whether the frame is 16:9 or 4:3 formatted are all the type of information that may be used in any combination to identify the frame and a retrieval process developed similar to that described above used.

Signatures may also be created from the luminance total value, quantizer scale, current bit rate, field move average in the X-direction, luminance differential value (from consecutive frames), the letterbox value, the total number of edge points, the total number and information of video text boxes, and the total number and information of faces.

### Color Histograms

Instead of using the signatures described above, one could calculate a color histogram for the frame and use this for the signatures. The color histogram could consist of any number of bins from any color space.

### Closed Captions

Closed caption data could also be used as a signature. The trigger words could be stored on the EPG and the extracted close caption text compared to find the start and end as described above.

### Combinations

Any combination of the above could be used to bookmark the frame or section of video.

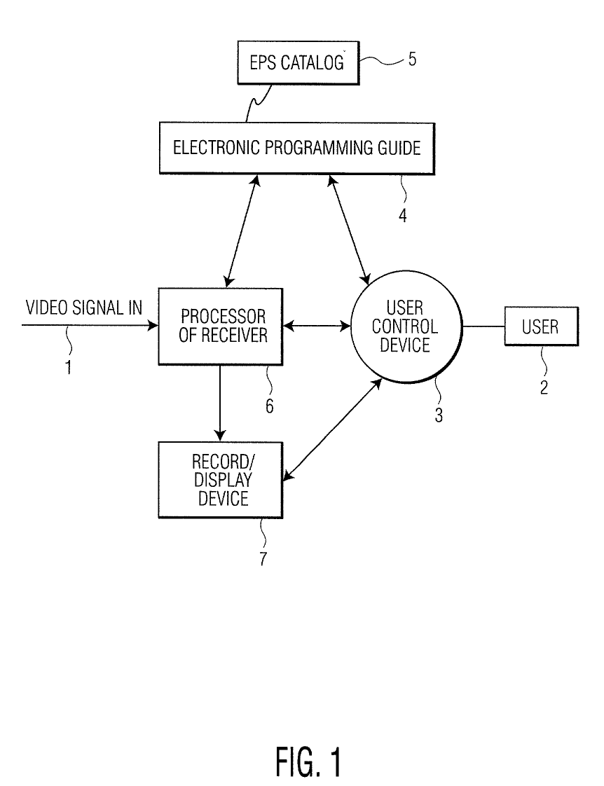

FIG. 1 depicts the various interactions within a system for controlling the display and/or recording of a given program carried on a video signal 1. A user 2 with a user control device 3 consults an electronic programming guide 4 to select a program to record from its catalog 5. Data for the selected program, including start and end times and signatures, are sent to a processor of a receiving device 6. This processor 6 then monitors the incoming video signal 1, looking for the signature for the start time of the selected program. When the signature is found, the processor 6 controls the record/display device 7 to record or display the selected program.

Similarly, the processor 6 may then continue to monitor the video signal 1 for the signature for the end of the selected program. When this is found, the processor 6 may control the display/recording device 7 to stop recording and/or displaying the program.

Turning now to FIG. 2, an example of a block signature extraction is depicted. A DCT block 8 of a given video frame has an array of values. These values are represented by the DC value 9, and the most significant AC values, 10. The DC value is represented by 3 bits in the 8 bit block signature 11. The AC values are represented by the remaining 5 bits.

### Audio

Audio information gathered from one or more frames could also be used as a signature. An audio signature may comprise information such as pitch (e.g., maximum, minimum, median, average, number of peaks, etc.), average amplitude, average energy, bandwidth and mel-frequency cepstrum coefficient (MFCC) peaks. Such a signature may be in the form of a single object segment extracted from the first 5 seconds of a video segment. As another example, the audio signature could be a set of audio signatures {A1, A2, . . . An} extracted from a designated time period following each identified video cut.

Of course, as is well known in the art, there are many methods of obtaining frame signatures from video frames. Thus, while we described what are the preferred embodiments of the present invention, further changes and modifications can be made by those skilled in the art without departing from the true spirit of the invention, and it is intended to include all such changes and modifications as come within the scope of the claims set forth below.

What is claimed is:

1. A method of processing a catalog of electronic programming information containing information for at least one program, said information including a start time and an end time of said at least one program, said method comprising:
obtaining a first value representing characteristics data of said at least one program at said start time; and
storing said first value in said catalog; and
obtaining a second value representing characteristics data of said at least one program at said end time; and
storing said second value program in said catalog;
when a user selects said at least one program for a use by a device with a program input, copying said first value and said second value to said device;
comparing said first and second value to corresponding values obtained from said program input to determine a start and stop time for said use.

2. The method of claim 1, wherein said program is a carried by a video signal source.

3. The method of claim 1, wherein said use for said program includes said device displaying said program.

4. The method of claim 1, wherein said use for said program includes said device recording said program.

5. The method of claim 1, wherein said value representing characteristics data gathered from said program is a signature generated by using a combination of features from a frame of said program.

6. The method of claim 1, wherein said value representing characteristics data gathered from said program is a color histogram generated from a frame of said program.

7. The method of claim 1, wherein said value representing characteristics data gathered from said program is generated from closed captioning data gathered from a frame of said program.

8. The method of claim 1, wherein said value representing characteristics data gathered from said program is generated from the audio portion from one or more frames of said program.

9. The method of claim 1, wherein said value representing characteristics data gathered from said program is a signature generated for a block of discrete cosine values for a frame.

10. The method of claim 1, wherein said value representing characteristics data gathered from said program is obtained from low level features.

11. A method of processing a catalog of electronic programming information containing information for at least one program, said information including a start time and an end time of said at least one program, said method comprising:
obtaining a first value representing characteristics data of an ending of a program immediately preceding said at least one program; and
storing said first value in said catalog; and
obtaining a second value representing characteristics data of said at least one program at said end time; and
storing said second value program in said catalog;
when a user selects said at least one program for a use by a device with a program input, copying said first value and said second value to said device;
comparing said first and second value to corresponding values obtained from said program input to determine a start and stop time for said use.

12. The method of claim 11, where said program is carried by a video signal source.

13. The method of claim 11, wherein said use for said program includes said device displaying said program.

14. The method of claim 11, wherein said use for said program includes said device recording said program.

15. The method of claim 11, wherein said value representing characteristics data gathered from said program is a signature generated by using a combination of features from a frame of said program.

16. The method of claim 11, wherein said value representing characteristics data gathered from said program is a color histogram generated from a frame of said program.

17. The method of claim 11, wherein said value representing characteristics data gathered from said program is generated from closed captioning data gathered from a frame of said program.

18. The method of claim 11, wherein said value representing characteristics data gathered from said program is generated from the audio portion from one or more frames of said program.

19. The method of claim 11, wherein said value representing characteristics of said DCT blocks is a signature generated for a block of DCT values for a frame.

20. The method of claim 11, wherein said value representing characteristics data gathered from said program is obtained from low level features.

21. A method of processing a catalog of electronic programming information containing information for at least one program, said information including a start time and an end time of said at least one program and the end time for an immediately temporarily preceding program, said method comprising:
obtaining a first value representing characteristics data of an ending of a program immediately preceding said at least one program; and
storing said first value in said catalog; and
obtaining a second value representing characteristics data of said at least one program at said start time; and
storing said second value program in said catalog,
when a user selects said at least one program for a use by a device with a program input, copying said first value and said second value to said device;
comparing said first value to corresponding value obtained from said program input to determine a time when said immediately temporarily preceding program ends;
next comparing said second value to corresponding value obtained from said program input to determine time for said use to begin.

22. A system for processing a catalog of electronic programming information, in which said catalog contains information for a program, wherein a start time and end time of said program is stored, in which said program is represented by characteristics data gathered from said program, said system comprising:
a video signal source of said program; and
a processor operatively coupled to said video signal source, said processor coupled to a electronic programming guide, and coupled to a user selection device, and logic output means; said processor configured to:
obtain a user programming selection from said user selection device; and
obtain said characteristic data, program channel selection, and program start and end time from said electronic programming guide containing said catalog; and
monitor said video signal source at time proximal to said program start time, comparing said characteristic data with complimentary characteristic data generated from video signal source; and
(a) when said characteristic data is equivalent to said complimentary characteristic data generated from video signal source, set logic output means to TRUE, and stop performing said comparison; or
(b) otherwise set logic output means to FALSE and continue performing said comparison on video signal source.

23. The system of claim 22, further comprising
monitor said video signal source at time proximal to said program end time, comparing said characteristic data with complimentary characteristic data generated from video signal source; and
(a) when said characteristic data is equivalent to said complimentary characteristic data generated from video signal source, set logic output means to FALSE, and stop performing said comparison; or
(b) otherwise set logic output means to TRUE and continue performing said comparison on video signal source.

24. The system of claim 22, wherein said processor is further operatively connected to a device for further processing said program, wherein a TRUE value for said logic output means causes said processor to turn on said device to the channel of said program.

25. The system of claim 24, further comprising that a FALSE value said logic output means causes said processor to turn off said device for further processing.
